(19) United States
(12) Patent Application Publication
(10) Pub. No.: US 2020/0019395 A1
(43) Pub. Date: Jan. 16, 2020

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Akira HIROSE, Kanagawa (JP)

(73) Assignee: FUJI XEROX CO., LTD., Tokyo (JP)

(21) Appl. No.: 16/459,566

(22) Filed: Jul. 1, 2019

(30) Foreign Application Priority Data
Jul. 11, 2018 (JP) 2018-131341

(51) Int. Cl. G06F 8/61; G06F 9/445

(52) U.S. Cl. CPC G06F 8/61; G06F 9/44505

(57) ABSTRACT

An information processing apparatus includes an acquisition unit and an install controller. The acquisition unit acquires an install instruction including an install target and an attribute of the install target. The install controller controls an installation of the install target in accordance with policy defined for an install target group obtained through classification using the attribute acquired by the acquisition unit.

### CROSS-REFERENCE TO RELATED APPLICATIONS

This application is based on and claims priority under 35 USC 119 from Japanese Patent Application No. 2018-131341 filed Jul. 11, 2018.

### BACKGROUND

### (i) Technical Field

The present disclosure relates to an information processing apparatus, an information processing system, and a non-transitory computer readable medium.

### (ii) Related Art

Techniques for restricting installations of programs and data are known. For example, Japanese Patent No. 6013061 describes a technique in which an installation of an application program is permitted or prohibited on the basis of the application name. Japanese Patent No. 6070286 describes a technique in which whether or not an application is to be installed is determined in accordance with resources required by the application that is to be installed. Japanese Unexamined Patent Application Publication No. 2015-41362 describes a technique in which an enhanced application is installed when the number of enhanced applications is less than, or equal to or less than, the upper limit number of enhanced applications which may be held in a host application.

If an installation is restricted regardless of the attribute of an install target which is an application program to be installed, for example, it is not possible to perform such restriction that an installation of an install target having a certain attribute is rejected. If permission or rejection of an installation needs to be set individually for all of the programs which may be installed, an increased number of programs cause a large amount of time and effort for the setting. In addition, in this case, an installation fails to be restricted for a new program for which permission or rejection of an installation has not been set.

### SUMMARY

Aspects of non-limiting embodiments of the present disclosure relate to a technique in which an installation is restricted in accordance with the attribute of an install target without defining install policies for individual install targets.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an acquisition unit and an install controller. The acquisition unit acquires an install instruction including an install target and an attribute of the install target. The install controller controls an installation of the install target in accordance with policy defined for an install target group obtained through classification using the attribute acquired by the acquisition unit.

### BRIEF DESCRIPTION OF THE DRAWINGS

Exemplary embodiment of the present disclosure will be described in detail based on the following figures, wherein:

FIG. 1 is a diagram illustrating an exemplary configuration of an information processing system according to an exemplary embodiment;

FIG. 2 is a diagram illustrating an exemplary hardware configuration of an image processing apparatus;

FIG. 3 is a diagram illustrating an exemplary policy list;

FIG. 4 is a diagram illustrating an exemplary functional configuration of the image processing apparatus;

FIG. 5 is a sequence chart of exemplary operations in the information processing system;

FIG. 6 is a diagram illustrating an exemplary install instruction;

FIG. 7 is a diagram illustrating an exemplary install list;

FIG. 8 is a flowchart of an exemplary process performed when an installation is rejected;

FIG. 9 is a sequence chart of exemplary operations performed when an installation is pending;

FIG. 10 is a diagram illustrating an exemplary pending list;

FIG. 11 is a diagram illustrating an exemplary message; and

FIG. 12 is a diagram illustrating the exemplary functional configuration of an image processing apparatus according to a modified example.

### DETAILED DESCRIPTION

### 1. Configuration

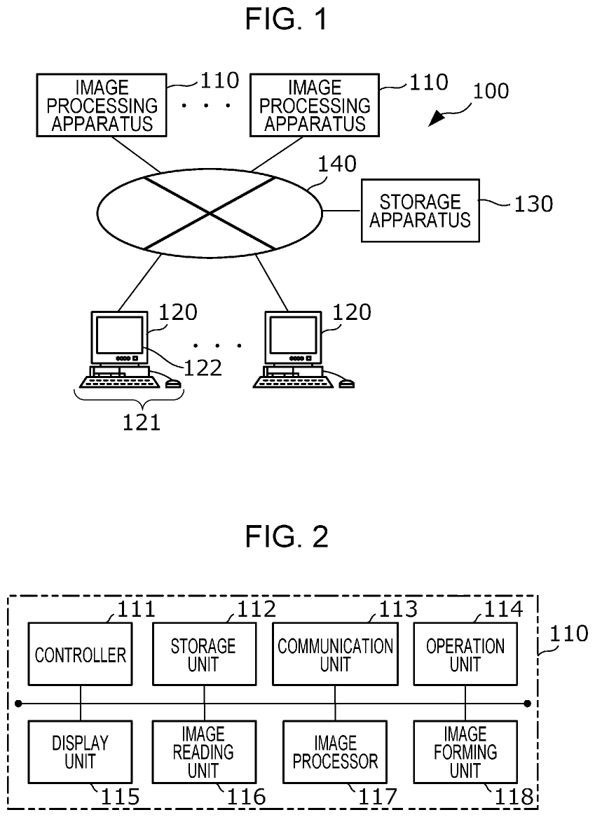

FIG. 1 is a diagram illustrating an exemplary configuration of an information processing system 100 according to the exemplary embodiment. The information processing system 100 is a system in which new installations to image processing apparatuses 110 are restricted. The “installation” indicates recording and setting programs and/or data for use on a computer. The information processing system 100 includes the image processing apparatuses 110, multiple terminal apparatuses 120, and a storage apparatus 130. The number of these apparatuses in FIG. 1 is exemplary, and is not limiting.

The image processing apparatuses 110, the terminal apparatuses 120, and the storage apparatus 130 are connected to one another via a communication line 140. The communication line 140 is used to perform communication among these apparatuses. As the communication line 140, for example, a private network such as a local area network (LAN) may be used.

FIG. 2 is a diagram illustrating an exemplary hardware configuration of an image processing apparatus 110. The image processing apparatus 110 has multiple functions, such as a print function, a copy function, a scan function, and a facsimile function. A new application program or new data is installed in the image processing apparatus 110. Thus, a new function or settings are added to the image processing apparatus 110.

The image processing apparatus 110 includes a controller 111, a storage unit 112, a communication unit 113, an operation unit 114, a display unit 115, an image reading unit 116, an image processor 117, and an image forming unit 118. The controller 111 controls the units of the image processing apparatus 110. As the controller 111, for example, a processor such as a central processing unit (CPU), and memories, such as a read only memory (ROM) and a random access memory (RAM), may be used. The storage unit 112 stores various types of data and programs. As the storage unit 112, for example, a hard disk drive may be used. The communication unit 113 is a communication interface connected to the communication line 140. The communication unit 113 performs communication via the communication line 140. The operation unit 114 is used for input of various types of information through operations performed by a user. As the operation unit 114, for example, operation keys and a touch panel may be used. The display unit 115 displays various images. As the display unit 115, for example, a liquid-crystal display may be used. The image reading unit 116 reads a document image and generates image data in accordance with the image. As the image reading unit 116, for example, an image scanner may be used. The image processor 117 performs various types of image processing, such as color correction and gradation correction, on image data received by the communication unit 113 or image data generated by the image reading unit 116. The image forming unit 118 forms an image in accordance with image data on a recording medium such as a sheet. As the image forming unit 118, for example, an electrophotographic-system printer may be used.

Back to FIG. 1, the terminal apparatuses 120 are used by users. Users include administrators who have the administrative right and public users who do not have the administrative right. The users use the terminal apparatuses 120, for example, to give various types of instructions to the image processing apparatuses 110. These instructions include, for example, print instructions and install instructions. Each terminal apparatus 120 includes an operation unit 121 and a display unit 122 in addition to a similar configuration including the controller 111 and the storage unit 112 which are described above. The operation unit 121 is used for input of various types of information through operations performed by a user. As the operation unit 121, for example, a keyboard and a mouse may be used. The display unit 122 displays various types of images. As the display unit 122, for example, a liquid-crystal display may be used.

The storage apparatus 130 stores various types of data used commonly by the image processing apparatuses 110. The storage apparatus 130 includes a similar configuration including the controller 111 and the storage unit 112 which are described above. The storage apparatus 130 stores, in advance, a policy list 131 indicating install policies predefined for the image processing apparatuses 110.

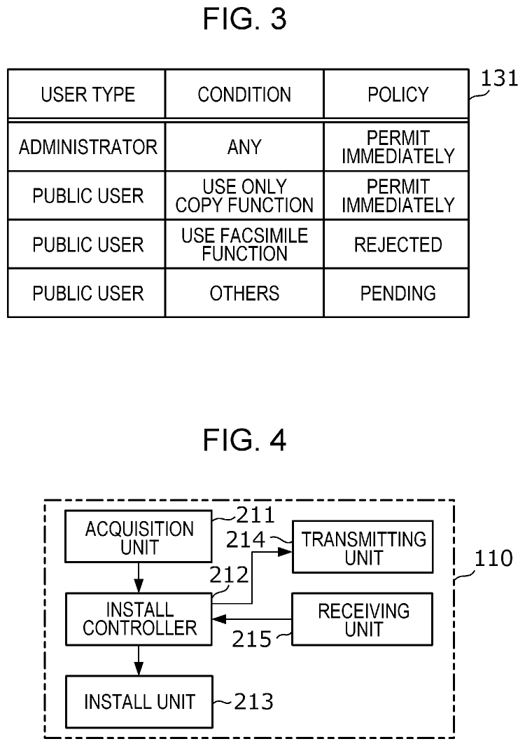

FIG. 3 is a diagram illustrating an exemplary policy list 131. The policy list 131 indicates install policies which are defined for combinations of the user type and the install target group indicating a common attribute. The install policies may be predefined, for example, by an administrator. An install target group does not necessarily include multiple install targets. An install target group is to include at least one install target. In the policy list 131, a user type, a condition indicating an install target group obtained through classification using attributes, and an install policy applied to the install target group are associated with one another. In the example in FIG. 3, the user type, “administrator”, the condition, “any”, and the policy, “permit immediately”, are associated with one another. This indicates that, when an administrator gives an install instruction, the installation is permitted immediately for any install target regardless of its attribute. In the example in FIG. 3, the user type, “public user”, the condition, “use only copy function”, and the policy, “permit immediately”, are associated with one another. This indicates that, when a public user gives an install instruction, the installation is permitted immediately for the install target group using only a copy function.

FIG. 4 is a diagram illustrating an exemplary functional configuration of an image processing apparatus 110. The image processing apparatus 110 includes an acquisition unit 211, an install controller 212, an install unit 213, a transmitting unit 214, and a receiving unit 215. These functions are implemented in such a manner that cooperation between a program stored in a memory and a processor executing the program causes the processor to perform computation or to control communication through the communication unit 113.

The acquisition unit 211 acquires an install instruction including an install target and the attribute of the install target. The “install instruction” indicates information about an instruction to install an install target. An install target may be a program such as an application program, or may be data such as setting data for indicating settings for a process performed by the image processing apparatus 110. The attribute of an install target is not an attribute specific to the install target, but an attribute common to at least one install target. This attribute may indicate characteristics and properties of an install target itself, or may indicate characteristics and properties of a function or process achieved by an install target. The characteristics and properties may be about information security, or may need management. For example, the attribute may include at least one of the following pieces of information: information about a function or process implemented by an install target; and information about whether or not communication is needed in the function or process, information about the communication target, and information about the communication method. The install instruction may be transmitted from a terminal apparatus 120.

The install controller 212 controls an installation of an install target on the basis of the attribute included in the install instruction and the install policies indicated by the policy list 131 stored in the storage apparatus 130. An install policy includes information about whether an installation is to be permitted, rejected, or pending. An installation is controlled in accordance with a policy corresponding to the attribute included in an install instruction. For example, in the install policies, when a policy indicating that an installation is to be permitted immediately is defined for the install target group obtained through classification using the attribute included in an install instruction, control is exerted in such a manner that the install target is installed in accordance with the install instruction. In contrast, in the install policies, when a policy indicating that an installation is to be rejected is defined for the install target group obtained through classification using the attribute included in an install instruction, control is exerted in such a manner that the install target is not installed. In addition, in the install policies, when a policy indicating that an installation is to be pending is defined for the install target group obtained through classification using the attribute included in an install instruction, control is exerted in such a manner that an installation of the install target is pending temporarily. In this case, control may be exerted in such a manner that the install target is installed in response to satisfaction of a defined condition.

The install unit 213 installs an install target, for which an installation has been permitted, in accordance with control exerted by the install controller 212. Specifically, the install unit 213 stores the install target in the storage unit 112, and performs a setting operation for enabling the install target to be used. This installation enables the install target to be used in the image processing apparatus 110.

The transmitting unit 214 transmits, to the terminal apparatus 120, information in accordance with control for the installation. The information may be transmitted, for example, through electronic mail. The content and the transmission destination of the information may be different depending on control for the installation. For example, when an installation of the install target is rejected, information for notifying that the installation has been rejected may be transmitted to the terminal apparatus 120 from which the install instruction is obtained. In contrast, when an installation of the install target is pending, information for inquiring whether or not the installation is to be performed may be transmitted to a terminal apparatus 120 which is predetermined as a transmission destination.

When information for inquiring whether or not an installation is to be performed is transmitted to the terminal apparatus 120 used by an administrator, the receiving unit 215 receives, from the terminal apparatus 120, a response indicating permission or rejection of the installation. The “response” indicates information indicating a response to the inquiry.

### 2. Operations

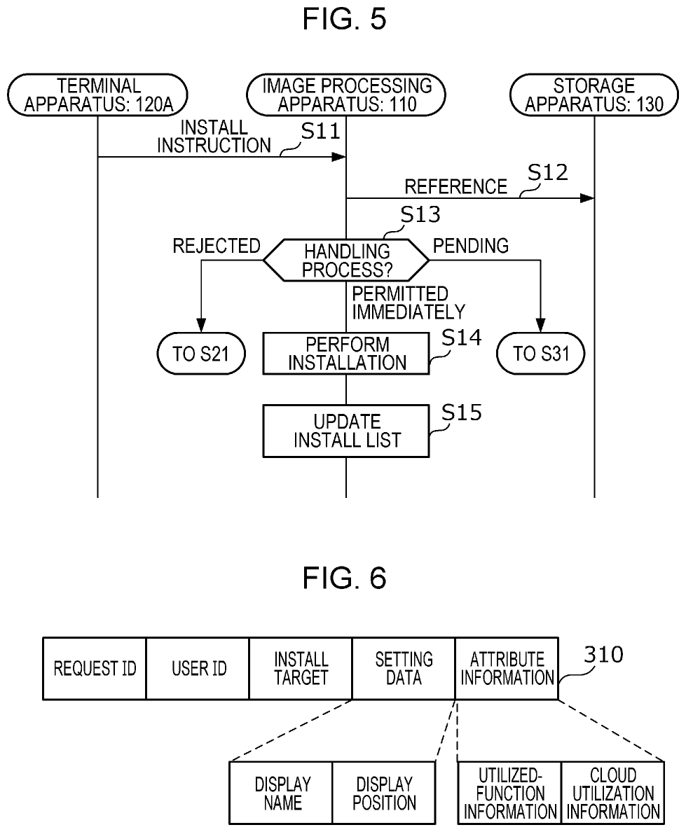

FIG. 5 is a sequence chart of exemplary operations performed in the information processing system 100. Herein, the terminal apparatuses 120 include a terminal apparatus 120A used by a public user and a terminal apparatus 120B used by an administrator. In the description below, the components of the terminal apparatuses 120A and 120B will be described with reference characters to which “A” and “B”, respectively, are added at the end.

When the public user uses an operation unit 121A to perform an operation of instructing an image processing apparatus 110 to install an install target, the terminal apparatus 120A transmits an install instruction 310 to the image processing apparatus 110 (step S11). The image processing apparatus 110 receives the install instruction 310 through the acquisition unit 211.

FIG. 6 is a diagram illustrating an exemplary install instruction 310. The install instruction 310 includes the request identifier (ID), the user ID, the install target, the setting data, and the attribute information. The request ID is information for identifying the install instruction 310. The user ID is information for identifying a person who has transmitted the install instruction 310. The install target is a program or data which is to be installed. The setting data is data used for an installation of the install target. The setting data includes, for example, the display name and the display position. When the install target is installed, an operation image used to operate the install target is displayed on the display unit 115. The display name is the name used when the operation image is displayed. The display name may be the same as or different from the name of the install target. The display position is information indicating the display position of the operation image on the display unit 115. For example, the display unit 115 is divided into multiple areas, and unique identification information is given to each area. In this case, as the display position, identification information given to an area in which the operation image is displayed on the display unit 115 may be used. The attribute information is information indicating the attribute of the install target. The attribute information includes utilized-function information and cloud utilization information. The utilized-function information indicates a function used by the install target, such as a copy function, a print function, a scan function, or a facsimile function. The cloud utilization information indicates whether or not the install target uses a function using cloud computing.

When the install instruction 310 is received, the image processing apparatus 110 performs the following processes. The install controller 212 accesses the storage apparatus 130, and refers to the policy list 131 stored in the storage apparatus 130 (step S12). Then, the install controller 212 determines a handling process for the install instruction 310 (step S13).

In this example, assume the case in which a public user whose user ID is “user01” gives an instruction to install an application program, “Pamphlet easy-preparation”. The application program is used to fold document image copies so that a user prepares a pamphlet easily. The install instruction 310 for the application program includes, for example, “req01” which is a request ID, “user01” which is a user ID, “Pamphlet easy-preparation” which indicates the application program, “Pamphlet easy-preparation” which is a display name, “8” which indicates a display position, “copy” which indicates utilized-function information, and “not used” which indicates cloud utilization information.

The user identified by using the user ID, “user01”, is classified as a public user. The utilized-function information, “copy”, included in the install instruction 310 indicates that the function used by the application program, “Pamphlet easy-preparation”, is only a copy function. In this case, in the policy list 131 in FIG. 3, the condition, “use only copy function”, associated with the user type, “public user”, is satisfied. Therefore, in step S13, the handling process according to the policy, “permit immediately”, associated with the user type, “public user”, and the condition, “use only copy function”, is determined to be performed (the determination result in step S13 is “permit immediately”). In this case, the install controller 212 supplies the install unit 213 with a control signal for exerting control in such a manner that the application program, “Pamphlet easy-preparation”, is installed. The install unit 213 installs the application program, “Pamphlet easy-preparation”, by using the setting data included in the install instruction 310, according to the control signal (step S14). When the installation is completed, an operation image whose display name is “Pamphlet easy-preparation” and which is used to perform an operation of giving an instruction to execute the application program is displayed in the area to which the identification information, “8”, is given and which is included in the display unit 115. In addition, the install controller 212 updates an install list 311 stored in the storage unit 112 on the basis of the application program, “Pamphlet easy-preparation”, installed in step S14 (step S15).

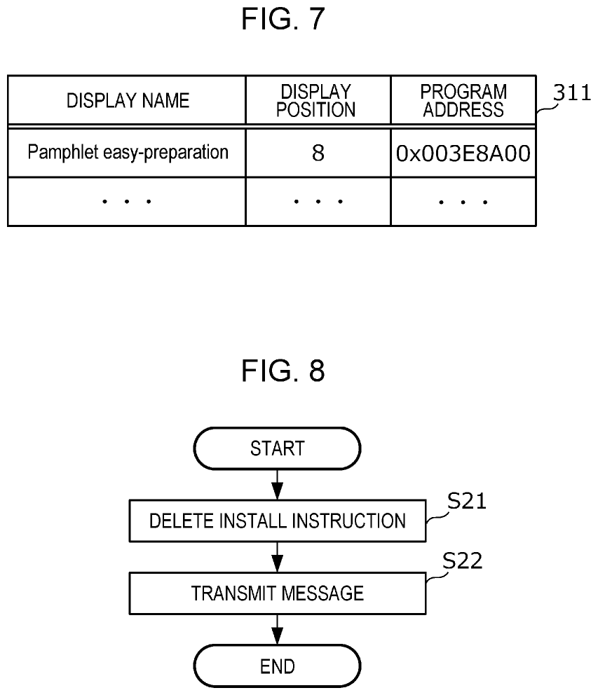

FIG. 7 is a diagram illustrating an exemplary install list 311. The install list 311 is used for management of install targets installed in the image processing apparatus 110. In this example, in the install list 311, the display name, “Pamphlet easy-preparation”, and the display position, “8”, which are included in the install instruction 310, and the address, “0x003E8A00”, indicating the location where the application program is stored are added in association with one another.

Assume the case in which the public user whose user ID is “user01” gives an instruction to install an application program, “Facsimile with large character size”. This application program is used to display screen information used in facsimile transmission in a large character size so that even a short-sighted individual may transmit a facsimile easily. The install instruction 310 for this application program includes, for example, “req02” which is a request ID, “user01” which is a user ID, “Facsimile with large character size” which indicates the application program, “My facsimile” which indicates a display name, “2” which indicates a display position, “facsimile” which indicates utilized-function information, and “not used” which indicates cloud utilization information.

As described above, the user identified by using the user ID, “user01”, is classified as a public user. The utilized-function information, “facsimile”, included in the install instruction 310 indicates that the function used by the application program, “Facsimile with large character size”, is a facsimile function. In this case, in the policy list 131 in FIG. 3, the condition, “use facsimile function”, associated with the user type, “public user”, is satisfied. Therefore, in step S13, the handling process according to the policy, “rejected”, associated with the user type, “public user”, and the condition, “use facsimile function”, is determined to be performed (the determination result in step S13 is “rejected”). In this case, the process proceeds to step S21.

FIG. 8 is a flowchart of an exemplary process performed when an installation is rejected. The install controller 212 deletes the install instruction 310 for the application program, “Facsimile with large character size” (step S21). Thus, the application is not installed. The transmitting unit 214 transmits, to the terminal apparatus 120A, a message indicating that the installation of the application program has been rejected (step S22). This message may include information for recommending consultation with an administrator. Upon reception of the message, the terminal apparatus 120A displays the message on the display unit 122A. The user views the message displayed on the display unit 122A, and thus finds that the installation of the application program, “Facsimile with large character size”, has been rejected.

Assume the case in which the user whose user ID is “user01” gives an instruction to install an application program, “Business-card cloud manager”. The application program is used to store business card information, indicating business cards which are read by using a scan function, in a server apparatus providing a service using cloud computing. The install instruction 310 for the application program includes, for example, “req03” which is a request ID, “user01” which a user ID, “Business-card cloud manager” which indicates the application program, “Client business card manager” which is a display name, “10” which indicates a display position, “scanning and file transfer” which indicates utilized-function information, and “use” which indicates cloud utilization information.

As described above, the user identified by using the user ID, “user01”, is classified as a public user. The utilized-function information, “scanning and file transfer”, included in the install instruction 310 indicates that the function used by the application program, “Business-card cloud manager”, is neither “only copy function” nor “facsimile function”. In this case, in the policy list 131 in FIG. 3, the condition, “others”, associated with the user type, “public user”, is satisfied. Therefore, in step S13, the handling process according to the policy, “pending”, associated with the user type, “public user”, and the condition, “others”, is determined to be performed (the determination result in step S13 is “pending”). In this case, the process proceeds to step S31.

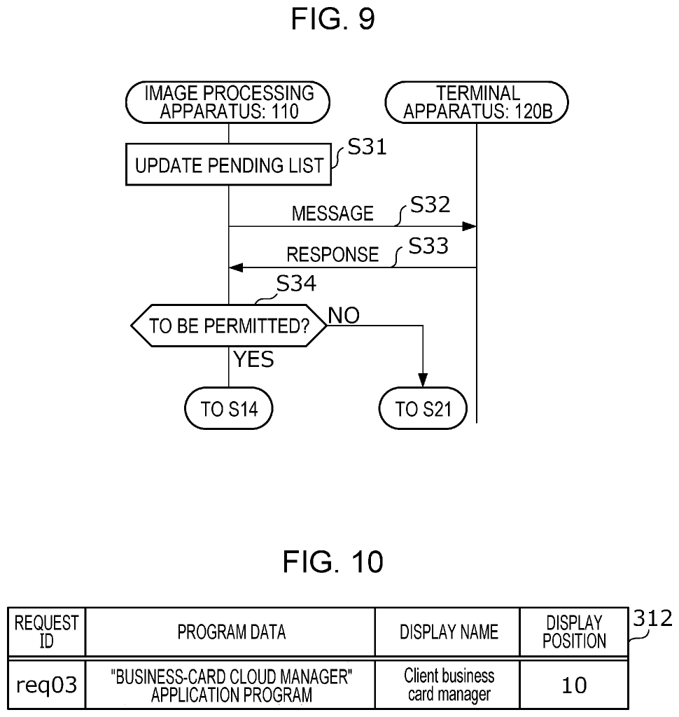

FIG. 9 is a sequence chart of exemplary operations performed when an installation is pending. The install controller 212 updates a pending list 312, which is stored in the storage unit 112, on the basis of the state in which “pending” is determined for an installation of the application program, “Business-card cloud manager” (step S31).

FIG. 10 is a diagram illustrating an exemplary pending list 312. The pending list 312 is used for management of install targets for which installations are pending. In this example, in the pending list 312, the request ID, “req03”, the application program, “Business-card cloud manager”, the display name, “Client business card manager”, and the display position, “10”, which are included in the install instruction 310 for the application program, are added in association with one another.

The transmitting unit 214 transmits, to the terminal apparatus 120B, a message 320 for inquiring whether or not the installation of the application program is to be permitted (step S32). In this case, the installation of the application program is pending temporarily until a response to the message 320 is returned.

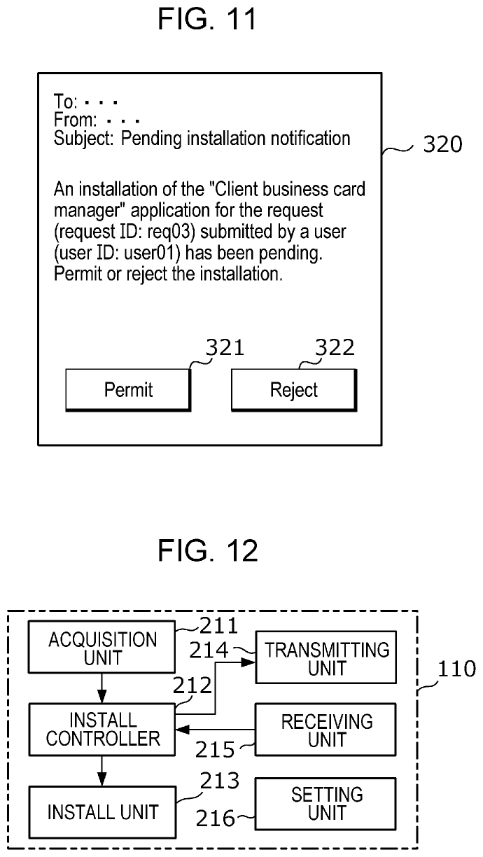

FIG. 11 is a diagram illustrating an exemplary message 320. The message 320 includes information for inquiring whether or not the installation of the application program, “Business-card cloud manager”, for which an instruction has been given by the public user whose user ID is “user01” is to be permitted. The message 320 includes a permission button 321 for receiving an operation for permitting the installation and a rejection button 322 for receiving an operation for rejecting the installation. When the installation of the application program is to be permitted, an administrator uses an operation unit 121B to press the permission button 321. In contrast, when the installation of the application program is to be rejected, the administrator uses the operation unit 121B to press the rejection button 322.

The terminal apparatus 120B transmits, to the image processing apparatus 110 from which the message 320 has been transmitted, an response indicating permission or rejection of the installation of the application program in accordance with the operation performed by the administrator (step S33). For example, if the permission button 321 is pressed, a response indicating permission of the installation is transmitted. In contrast, if the rejection button 322 is pressed, a response indicating rejection of the installation is transmitted. The image processing apparatus 110 receives the response through the receiving unit 215.

The install controller 212 determines whether or not the installation is to be permitted in accordance with the received response (step S34). For example, if the response indicates permission of the installation, it is determined that the installation is to be permitted (the determination result in step S34 is YES). In this case, the process proceeds to step S14 described above, and the processes in step S14 and its subsequent steps are performed. In contrast, if the response indicates rejection of the installation, it is determined that the installation is to be rejected (the determination result in step S34 is NO). In this case, the process proceeds to step S21 described above, and the processes in step S21 and its subsequent steps are performed.

In the exemplary embodiment described above, an image processing apparatus 110 is used as an “information processing apparatus” provided by the present disclosure.

According to the exemplary embodiment described above, a program and data are installed in an image processing apparatus 110 in the scope of the install policies in accordance with an install instruction given by a public user. Thus, not only an administrator but also a public user adds a desired function and desired settings to an image processing apparatus 110. In addition, installations are restricted in accordance with the policies defined for install target groups obtained through classification using the attributes of install targets. Therefore, compared with the case in which install policies are defined for individual install targets, time and effort for defining the install policies are reduced. Further, the attribute of an install target includes information about a function implemented by the install target. Accordingly, an installation of an install target is restricted in accordance with the information about the function implemented by the install target. When the policy defined for the install target group obtained through classification using the attribute of an install target indicates rejection of the installation, an installation of the install target is not performed, thus preventing an installation of an install target having an attribute which does not match the policy. In addition, the install policies include a policy of making an installation pending. Thus, for an install target having an attribute for which it is difficult to determine unconditionally whether or not the installation is to be permitted, the installation is pending until a defined condition is satisfied, for example, until a response indicating permission of the installation is received. In this case, an administrator may determine whether or not the installation is to be permitted. Further, the install policies include permission of an installation. Thus, when an install target has an attribute matching the policy, the install target desired by a user is installed. Furthermore, the policy list 131 indicating install policies which are common to the image processing apparatuses 110 is stored in the storage apparatus 130. When an install policy is changed, only the policy list 131 may be updated. Thus, compared with the case in which the policy list 131 indicating the install policies is stored in each image processing apparatus 110, time and effort for management of the install policies are reduced.

### 3. Modified Examples

The exemplary embodiment described above is an example of the present disclosure. The present disclosure is not limited to the exemplary embodiment described above. For example, the exemplary embodiment described above may be changed as described below. In addition, two or more modified examples described below may be combined with one another for implementation.

In the exemplary embodiment described above, when an installation is rejected, an installable substitute install target may be recommended to the user. In this case, for example, an install target, which has a function corresponding to the install target included in the install instruction 310, is selected as a candidate from install targets for which installations have been already permitted and which are indicated by the install list 311. The “corresponding function” may be, for example, a function having at least common or similar part. The transmitting unit 214 may transmit, to the terminal apparatus 120A, information for recommending the install target selected as a candidate. This information may be, for example, a message, “The application program, ‘Facsimile with large character size’, has been rejected. However, an application program, ‘Enlarge characters’, having a similar function may be installed.” The terminal apparatus 120A may display the information on the display unit 122A. According to the modified example, when an installation of an install target is not performed in accordance with the install instruction 310, the user finds an installable substitute install target.

In the exemplary embodiment described above, for an install target having an attribute which is incompatible with an application program or data having been already installed in the image processing apparatus 110, settings may be made so that an installation of the install target is rejected or pending regardless of an operation performed by an administrator. The incompatible attribute indicates, for example, an attribute which stops or disables the function or process implemented by an application program or data having been already installed. In this case, as illustrated in FIG. 12, the image processing apparatus 110 includes a setting unit 216 in addition to the functions in FIG. 4. For the new install target group obtained through classification using the attribute incompatible with another install target having been already installed, the setting unit 216 sets a policy of rejecting an installation or the policy of making an installation pending. For example, assume the case in which an application program, “Suppressive error-transmission facsimile”, has been already installed in an image processing apparatus 110. The application program is used to transmit a facsimile after the telephone number of a transmission destination is input twice. In this case, an application program for transmitting a facsimile when the telephone number of a transmission destination is input only once has an attribute incompatible with the application program, “Suppressive error-transmission facsimile”, which has been already installed. Therefore, for the install target group having an attribute, “facsimile transmission with single input of telephone number”, the policy of rejecting an installation or the policy of making an installation pending may be set regardless of an operation performed by an administrator. Specifically, the user type, “public user”, the condition, “facsimile transmission with single input of telephone number”, and the policy of “rejected” or “pending” may be transmitted to the storage apparatus 130, and may be added to the policy list 131 in association with one another. According to the modified example, compared with the case in which an administrator defines install policies for all of the install target groups, time and effort of the administrator are reduced.

In the exemplary embodiment described above, the attribute information is not limited to the utilized-function information and the cloud utilization information. For example, the attribute information may include information about the cost for use of the install target. In this case, for example, when an install target is used with no charge, an installation of the install target may be permitted immediately. In contrast, when an install target is used with charge or is used with charge incurred after a certain use period, an installation of the install target may be rejected or pending. In addition, the attribute information may include information indicating whether or not the install target transfers data to the outside of an image processing apparatus 110. In this case, for example, when an install target does not transfer data to the outside, an installation of the install target may be permitted immediately. In contrast, when an install target transfers data to the outside, an installation of the install target may be rejected or pending. Further, the attribute information may include information indicating a communication destination if the install target performs data communication. In this case, for example, when the install target transmits data to the communication destination connected not over the Internet, an installation of the install target may be permitted immediately. In contrast, when the install target transmits data to the communication destination connected over the Internet, an installation of the install target may be rejected or pending. Furthermore, the attribute information may include information indicating the creator or distributor (hereinafter referred to as a “creator or the like”) of the install target. In this case, for example, when the creator or the like of an install target is a predetermined creator or the like or when the install target is given a digital signature, an installation of the install target may be permitted immediately. In contrast, when the creator or the like is a creator or the like other than predetermined creators or when the install target is not given a digital signature, an installation of the install target may be rejected or pending. Furthermore, when an install target is data, the attribute information may include information indicating whether or not the data is used to add a new function to an image processing apparatus 110. In this case, for example, if the data of the install target is used just to change settings of an existing function of the image processing apparatus 110 and not to add a new function, an installation of the install target may be permitted immediately. In contrast, if the data is used to add a new function to the image processing apparatus 110, an installation of the install target may be rejected or pending.

In the exemplary embodiment described above, it may be determined whether an installation is to be rejected or pending in response to satisfaction of a defined condition. For example, when an install target is used with charge, it may be determined whether or not an installation is to be permitted in accordance with the state in which a round robin or settlement for payment has been done. It may be determined whether or not a round robin or settlement for payment has been done, for example, on the basis of information supplied from an electronic round robin approval system. In another example, it may be determined whether or not an installation is to be pending in accordance with input of information needed for the installation of the install target.

In the exemplary embodiment described above, an operation for giving an instruction to install an install target may be performed on an image processing apparatus 110. In this case, the storage apparatus 130 stores various programs and data which are install targets and their attribute information. A user uses the operation unit 114 to perform an operation of giving an instruction to install an install target. The image processing apparatus 110 may acquire the install target, for which an instruction for installation has been given, and the attribute information of the install target from the storage apparatus 130 in accordance with the operation. An apparatus in which various programs and data, which are install targets, and their attribute information are stored may be different from the storage apparatus 130.

In the exemplary embodiment described above, the storage unit 112 of each image processing apparatus 110 may store the policy list 131. In this case, the storage apparatus 130 is not necessarily provided.

In the exemplary embodiment described above, the method in which an administrator responds to the message 320 is not limited to the method in which the permission button 321 or the rejection button 322 is pressed. For example, an administrator may input permission or rejection of an installation through an operation using the operation unit 121B. In this case, a message indicating permission or rejection of an installation may be transmitted from the terminal apparatus 120B to the image processing apparatus 110 in accordance with an operation performed by the administrator. In another example, an administrator may move to the image processing apparatus 110 from which the message 320 has been transmitted, and may input permission or rejection of an installation through an operation using the operation unit 114.

In the exemplary embodiment described above, when an install target has multiple attributes and when the install policies corresponding to the attributes are different from one another, a handling process according to the policy having the highest priority among the install policies may be determined to be performed. The priority may be given according to a predefined rule. For example, the priority for the policy, “rejected”, may be the highest, and the priority for the policy, “permit immediately”, may be the lowest. In this case, for example, when the install policies corresponding to the attributes of an install target include “permit immediately” and “rejected”, the handling process for the policy, “rejected”, may be determined to be performed. The priority may be different depending on each user.

In the exemplary embodiment described above, the install policy may be different depending on persons who use an install target. For example, when an install target having a certain attribute is used only by a user who has transmitted an install instruction, the installation may be pending. In contrast, when the install target is shared in the entire organization to which the user belongs, the installation may be permitted immediately. In another example, for an install target having a certain attribute, when only a user who has transmitted an install instruction uses the install target, the installation may be permitted immediately. In contrast, when other users use the install target, the installation may be pending.

In the exemplary embodiment described above, the installation destination of an install target is not limited to an image processing apparatus 110. As long as the installation destination of an install target is an apparatus in which the install target may be installed, any apparatus may serve as an installation destination. For example, the installation destination of an install target may be a printer, a scanner, a copier, or a facsimile which implement the respective single functions provided for the image processing apparatus 110, or may be a personal computer, a tablet terminal, or a smartphone.

Steps in the process performed in the information processing system 100 are not limited to the example described in the exemplary embodiment described above. The steps in the process may be switched as long as no contradiction occurs. The present disclosure may be provided as a method including steps in the process performed in the information processing system 100.

The present disclosure may be provided as a program executed in the image processing apparatuses 110, the terminal apparatuses 120, or the storage apparatus 130. The program may be downloaded through a communication line such as the Internet, or may be provided by recording the program in a computer-readable recording medium, for example, a magnetic recording medium (such as a magnetic tape or a magnetic disk), an optical recording medium (such as an optical disk), a magneto-optical recording medium, or a semiconductor memory.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an acquisition unit that acquires an install instruction including an install target and an attribute of the install target; and
an install controller that controls an installation of the install target in accordance with policy defined for an install target group obtained through classification using the attribute acquired by the acquisition unit.

2. The information processing apparatus according to claim 1,
wherein the attribute includes information about a function implemented by the install target.

3. The information processing apparatus according to claim 1,
wherein, when the policy indicates rejection of the installation, the install controller exerts control so as not to install the install target.

4. The information processing apparatus according to claim 2,
wherein, when the policy indicates rejection of the installation, the install controller exerts control so as not to install the install target.

5. The information processing apparatus according to claim 3, further comprising:
a transmitting unit that, when the policy indicates rejection of the installation, transmits, to a source from which the install instruction is acquired, information for recommending a different install target, the different install target having a function corresponding to a function of the install target, the different install target being an install target for which a policy of permission of the installation is defined.

6. The information processing apparatus according to claim 4, further comprising:
a transmitting unit that, when the policy indicates rejection of the installation, transmits, to a source from which the install instruction is acquired, information for recommending a different install target, the different install target having a function corresponding to the function of the install target, the different install target being an install target for which a policy of permission of the installation is defined.

7. The information processing apparatus according to claim 1,
wherein, when the policy indicates a policy of making the installation pending, the install controller exerts control so as to install the install target in response to satisfaction of a defined condition.

8. The information processing apparatus according to claim 2,
wherein, when the policy indicates a policy of making the installation pending, the install controller exerts control so as to install the install target in response to satisfaction of a defined condition.

9. The information processing apparatus according to claim 3,
wherein, when the policy indicates a policy of making the installation pending, the install controller exerts control so as to install the install target in response to satisfaction of a defined condition.

10. The information processing apparatus according to claim 4,
wherein, when the policy indicates a policy of making the installation pending, the install controller exerts control so as to install the install target in response to satisfaction of a defined condition.

11. The information processing apparatus according to claim 5,
wherein, when the policy indicates a policy of making the installation pending, the install controller exerts control so as to install the install target in response to satisfaction of a defined condition.

12. The information processing apparatus according to claim 6,
wherein, when the policy indicates a policy of making the installation pending, the install controller exerts control so as to install the install target in response to satisfaction of a defined condition.

13. The information processing apparatus according to claim 7, further comprising:
a transmitting unit that, when the policy indicates the policy of making the installation pending, transmits, to a predetermined transmission destination, information for inquiring whether or not the installation is to be permitted,
wherein the install controller controls the installation of the install target in accordance with a response to the inquiry.

14. The information processing apparatus according to claim 1,
wherein, when the policy indicates permission of the installation, the install controller exerts control to install the install target.

15. An information processing system comprising:
a storage apparatus; and
a plurality of information processing apparatuses,
wherein the storage apparatus includes
a storage unit that stores an install target group and a policy in association with one another, the install target group being obtained through classification using an attribute of an install target, the policy being defined for the install target group, and
wherein each of the plurality of information processing apparatuses includes
an acquisition unit that acquires an install instruction including the install target and the attribute of the install target, and
an install controller that controls an installation of the install target in accordance with the policy stored in the storage unit, the policy being associated with the install target group obtained through classification using the attribute acquired by the acquisition unit.

16. The information processing system according to claim 15, further comprising:
a setting unit that sets a policy of rejecting the installation or a policy of making the installation pending, for a new install target group obtained through classification using an attribute incompatible with a different install target that has been already installed,
wherein the storage unit stores the new install target group and the policy in association with one another, the policy being set by the setting unit.

17. A non-transitory computer readable medium storing a program causing a computer to execute a process comprising:
acquiring an install instruction including an install target and an attribute of the install target; and
controlling an installation of the install target in accordance with policy defined for an install target group obtained through classification using the acquired attribute.
